(19) United States
(12) Patent Application Publication
(10) Pub. No.: US 2025/0300181 A1
(43) Pub. Date: Sep. 25, 2025

(54) A SLURRY, AN ELECTRODE, AND A METHOD FOR MANUFACTURING AN ELECTRODE FOR LITHIUM-ION BATTERIES

(71) Applicant: LECLANCHÉ, SA, Yverdon-les-Bains (CH)

(72) Inventors: Hilmi Buqa, Yverdon-les-Bains (CH); Pierre Blanc, Yverdon-les-Bains (CH)

(21) Appl. No.: 18/841,596

(22) PCT Filed: Mar. 3, 2023
(86) PCT No.: PCT/EP2023/055432

§ 371 Date: Aug. 26, 2024

(30) Foreign Application Priority Data
Mar. 4, 2022 (LU) LU102918

(51) Int. Cl. H01M 4/62; C01G 53/502; C09J 105/00; C09J 109/06; H01M 4/04; H01M 4/1391; H01M 4/505; H01M 4/525

(52) U.S. Cl. CPC H01M 4/622; C01G 53/502; C09J 105/00; C09J 109/06; H01M 4/0404; H01M 4/1391; H01M 4/505; H01M 4/525; C01P 2002/50; C01P 2006/40; C09J 2203/326

(57) ABSTRACT

A slurry, an electrode, and a method for manufacturing an electrode for Lithium-ion batteries, wherein the electrode is a compound consisting in a water-based binder system and an electrochemically activatable compound with Li-metal oxides comprising Ni, wherein the Ni amount in Metal (LiMeO2) is at least 80% wt, and wherein the pH value in the slurry is adjusted to be between 9 to 10.5.

### CROSS REFERENCE TO RELATED APPLICATIONS

The present application claims priority to PCT/EP2023/0055432, filed on Mar. 3, 2023, and thence to Luxembourg patent application LU102918 filed on Mar. 4, 2022. The aforementioned applications are hereby incorporated by reference in their entirety.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

SEQUENCE LISTING INCLUDED AND INCORPORATED BY REFERENCE HEREIN

Not applicable.

### BACKGROUND OF THE DISCLOSURE

### Field of the Disclosure

Lithium-ion batters (LIBs) are a type of a rechargeable battery, are playing a crucial role in today's transition to a sustainable energy production and consumption. LIBs have been used widely for many years for portable electronics and electric vehicles and see a growing use in train, maritime and aerospace applications, as well as large scale storage applications in wind and solar parks.

In the batteries, lithium ions move from the negative electrode through an electrolyte to the positive electrode during discharge, and back when charging. LIBs use intercalated lithium ions as the material at the positive electrode and typically graphite at the negative electrode.

LIBs have a high energy density, no memory effect and low self-discharge. They can however be a safety hazard since they contain flammable electrolytes, and if damaged or incorrectly charged, can lead to explosions and fires.

Chemistry, performance, cost, and safety characteristics vary across LIBs types. The earliest concepts of rechargeable lithium-ion batteries date back to 1980, when lithium cobalt oxide (LiCoO₂) was initially introduced as active material in cathodes. Due to the high toxicity of Co, its high costs and thermal instability, the general trend was the total or partial substitution of Co with other metals, e.g. lowering the Co content with increasing Ni/Metal ratio, leading to an increase in capacity (J.B. Goodenough, Y. Kim (2010), Chemistry of Materials 22, 587-603). LiNiMnCoO₂ or NMC stands for Lithium Nickel (Ni) Manganese (Mn) Cobalt (Co) Dioxide (LiNiMnCoO₂) or shortly, Lithium Metal Dioxide (LiMeO₂), where metal is represented by Ni, Mn and Co within a certain proportion or ratio. This is nowadays the most common cathode material for commercial lithium-ion cells, isostructural to LiCoO₂, where Ni:Mn:Co=1:1:1 (NMC111, equimolar metal content). The energy density for the cells using graphite-based cells using LCO, NMC 111 or the traditional LiFePO₄ (LFP) as a cathode material is in the range up to 120-160 Wh/kg. Nowadays, large format cells need to deliver energy densities higher than 200 Wh/kg. To achieve the market demands for lithium-ion batteries (LIB), the energy-and/or power density on the cell level need to be remarkably improved. On the cathode side, these can be accomplished in several ways:
introduce high capacity electrodes materials (such as Ni-rich NMC, layered oxides, Li-rich layered oxides used as positive electrode materials, cathode materials) and
introduce high voltage cathode (>4.6 V vs metallic lithium) materials, e.g. high Voltage LiNi_{0.5}Mn_{1.5}O₂−, high-Ni LiNi_{1-x-y}MnₓAl_{y}O₂ (NMA) and/or olivine high voltage LiCoPO4 cathodes.

As a binder material for LIB electrodes today a widely used polymer is PVdF (polyvinylidene fluoride).

Challenges facing LIBs today are to be found in areas such as enhancing lifetime, energy density, safety, cost, and increasing charging speed, among others. Development is focused on topics such as non-flammable electrolytes as a pathway to increased safety based on the flammability and volatility of the organic solvents used in the typical electrolyte. Strategies include aqueous lithium-ion batteries, ceramic solid electrolytes, polymer electrolytes, ionic liquids, and heavily fluorinated systems.

In efforts towards greener and less toxic LIBs, aqueous binder-based cathodes have been proposed with superior electrochemical performance, such as Lithium Nickel Manganese Cobalt Oxide (LiNiMnCoO₂)-NMC, Lithium Nickel Cobalt Aluminum Oxide (LiNiCoAlO₂)-NCA, or high-voltage LiNi_{0.5}Mn_{1.5}O₄ electrodes.

NMC or Lithium Nickel Manganese Cobalt Oxide (LiNiMnCoO₂) are among the most successful Li-ion systems for cathodes. Similar to Li-manganese, these systems can be tailored to serve as Energy Cells or Power Cells. For example, NMC in an 18650 cell for moderate load condition has a capacity of about 2,800 mAh and can deliver 4 A to 5 A; NMC in the same cell optimized for specific power has a capacity of only about 2,000 mAh but delivers a continuous discharge current of 20 A. A silicon-based anode will go to 4,000 mAh and higher but at reduced loading capability and shorter cycle life. Silicon added to graphite has the drawback that the anode grows and shrinks with charge and discharge, making the cell mechanically unstable.

The secret of NMC lies in combining nickel, cobalt and manganese. An analogy of this is table salt in which the main ingredients, sodium and chloride, are toxic on their own but mixing them serves as seasoning salt and food preserver. Nickel is known for its high specific energy but poor stability; manganese has the benefit of forming a spinel structure to achieve low internal resistance but offers a low specific energy. Combining the metals enhances each other strengths.

NMC is the battery of choice material for power tools, e-bikes and other electric powertrains. The cathode combination is typically one-third nickel, one-third manganese and one-third cobalt in metal (LiMeO₂), also known as 1-1-1. This offers a unique blend that also lowers the raw material cost due to reduced cobalt content. Another successful combination is NCM532 with 5 parts nickel, 3 parts cobalt and 2 parts manganese (5-3-2). Other combinations using various amounts of cathode materials are possible.

Battery manufacturers move away from cobalt systems toward high nickel content cathodes because of the high cost of cobalt. Nickel-based systems have a higher energy density, lower cost, and longer cycle life than the cobalt-based cells but they have a slightly lower voltage.

Lithium Nickel Cobalt Aluminum Oxide (LiNiCoAlO₂)-Batteries containing NCA cathode material have been developed around 1999 for special applications. NCA cathode based batteries share similarities with NCM cathode batteries by offering high specific energy, reasonably good specific power and a long life span while at the same time are considered less save and costly. Stability gains can be seen by adding aluminum to the chemistry.

High-voltage (LiNi_{0.5}Mn_{1.5}O₄)-LNMO cathodes are promising for next-generation high-performance lithium-ion batteries due to their high energy density, high operating voltage (˜4.7V vs. Li), low fabrication cost, and low environmental impact. However, the short cycle life of LNMO caused by rapid capacity decay during cycling still forms a challenge.

Compared with conventional organic PVdF-based electrodes, the NCM, NCA and LNMO electrodes display a very uniform distribution of carbon particles together with strong adhesion among the particles and with the current collector, leading to significantly mitigated crack formation and delamination of the electrode upon repeated delithiation/lithiation processes. Additionally, these electrodes offer enhanced Li⁺diffusion kinetics, reduced polarization, therefore, excellent high C-rate capability, and extremely stable cycling performance even at elevated temperatures such as >50° C. They also benefit from low cost, environmentally friendliness, and easy disposability-recyclability.

Despite all the advances made in aqueous binder-based cathodes for lithium-ion batteries, on our way to a sustainable Lithium ion battery there still is a deeply felt desire to
avoid and/or reduce the PVdF content in electrodes,
reduce the overall binder content in the electrodes,
enhance lamination of separators to electrodes manufactured from aqueous solutions,
increase the cohesive adhesion between particles within the electrode structure,
increase the chemical-and electrochemical stability for the cathode,
increase the cell safety through using more stable water-based binders,
increase the adhesion of the electrode mass to the current collector,
increase recyclability of the electrode material, and last but not least
reduce manufacturing cost

These objectives are achieved by providing a slurry, and a method for manufacturing an electrode, an electrode, and a battery containing the electrode, with the elements, compositions and method steps according to the disclosure below.

### SUMMARY OF THE DISCLOSURE

The present invention is directed at a slurry for manufacturing an electrode for lithium-ion cells, an electrode made using the slurry, and a method for manufacturing an electrode for Lithium-ion batteries (LIBs).

### BRIEF DESCRIPTION OF THE DRAWINGS

The disclosure will be described based on figures. It will be understood that the embodiments and aspects of the disclosure described in the figures are only examples and do not limit the protective scope of the claims in any way. The disclosure is defined by the claims and their equivalents. It will be understood that features of one aspect or embodiment of the disclosure can be combined with a feature of a different aspect or aspects of other embodiments of the disclosure, in which:

FIG. 1 shows an example of an electrochemical cell according to a preferred embodiment of the invention;

FIG. 2a shows a second example of an electrochemical cell according to a preferred embodiment of the invention;

FIG. 2b shows how electrochemical cells according to a preferred embodiment of the invention can be stacked to form a battery;

FIG. 3 shows filling a battery comprising a plurality of stacked electrochemical cells with electrolyte;

FIG. 4 shows the filled battery of FIG. 3; and

FIG. 5 shows a comparison cycle stability graph for G/NMC622 and G/NMCA with 88% Ni, according to the preferred embodiment of the invention as shown in FIGS. 1 to 4.

### DETAILED DESCRIPTION OF THE DISCLOSURE

The present invention is slurry for manufacturing an electrode for lithium-ion cells, wherein the slurry is a compound consisting in a water-based binder system, i.e. a mixture of one or more polymer binders dissolved in an aqueous solution, and an electrochemically activatable compound, i.e. cathode materials that convert electricity and chemical potential through electrochemical intercalation reactions, with Li-metal oxides comprising Ni (also called Ni rich oxides), and Li-rich oxides, i.e. cathode materials containing more Li than regular stochiometric 1:1 LiMeO₂-oxides compounds, wherein the Ni amount in Metal (LiMeO₂) is at least 80% wt, and wherein the pH value in the slurry is adjusted to be between 9 to 10,5.

An example of lithium-rich layered oxide cathode materials is Li_{1.2}Mn_{0.5100}Ni_{0.2175}Co_{0.0725}O₂.

The technical advantages of using an Ni amount in Metal of at least >80% over using lesser amounts is resulting in improved capacity and reduced cost due to reduction of cobalt content within the cathode material.

To be able to employ Ni amount in Metal (LiMeO₂) of at least >80% to reach a functioning battery cell, recipes and steps of the mixing process have to be adapted to control pH values of the resulting slurry within a specific range of 9 to 10,5 in order to control the surface reactivity of the materials, which is higher in comparison to low-Ni content cathode materials.

Properly stabilising of the Li-NMC slurry with Ni amount in Metal (LiMeO₂) of at least 80% by tightly controlling the pH value in the slurry according to the invention to be in a range between 9 and 10,5 will lead to improved cohesive adhesion between particles within the electrode structure, and thus significantly more stable electrodes can be obtained.

The cathode active materials used for Li-ion electrodes with a high Ni content can have very high pH values (pH>11.5) during processing in the slurry. Water-based slurries with higher pH are very critical to process due to corrosive reactions or/and agglomeration of active and conductive materials. Higher or uncontrolled pH can also lead to binder gelation. To avoid such behaviors with water-based binder slurries, control of the pH of the slurry is essential.

The pH value of the binder solutions produced can be adjusted over a wide range from acidic to neutral to basic conditions, e.g., by adding acrylates (polyacrylic acid-PAA, polyethylene-co-acrylic acid-PEAA, etc.), phosphoric acid, citric acid, LiH₂SO₄, LiH₂PO₄, ammonia, etc. The preferred way for using such pH regulator (buffer solutions) compounds in electrode pastes is to provide this compound also with adhesive properties and use it as a thickener for the prepared slurry solution.

For example, since acrylates contain acidic groups, they correct (reduce) the high pH of the solutions containing higher pH materials and reduce the very high interfacial free energy between active and inactive particles, especially when carbon black particles are used as the conductive material, which is known for its hydrophobic character. Acrylic groups also enhance the surface reaction with the current collector and, as a result, provide high adhesion of the electrode particles and the current collector. The preferred choice for lowering pH and improving electrode adhesion is PAA (polyacrylic acid), which acts both as a binder and as a pH regulator.

For the water-based binder slurries according to the invention the binder combination is used in a way that allows control of the pH of the slurry and protect the active surface of active cathode material and conductive materials from electrolytic corrosion and electrochemical decomposition on the surface of the active material.

By coating the electrodes with a pH-controlled slurry (pH=9-10.5) corrosion of the (aluminium) current collectors can be avoided.

Higher Ni-contents in LiMe-oxides also enhances the capacity (Ah/kg) used as a cathode material for Li-ion cells, e.g. the capacity for NCM111 is ca. 150 Ah/kg and for NCM cathode material containing over 80% Ni is over 190 Ah/kg.

Furthermore, it enables the electrode (cathode) manufacturing with environmentally friendly water-based binders, lamination of electrodes produced with water-based binders to the separator, increasing interface stability and reducing the risk of dendrite formation. Ni-rich cathodes manufactured according to the present invention show good chemical and electrochemical cycling stability.

In a preferred embodiment, the electrochemically activatable compound may be chosen from the group consisting of NCM-types, NCA-types, NCMA-types (nickel-cobalt-manganese-aluminium oxide) and High voltage Li-NMO (LiNi_{0.5}Mn_{1.5}O₄) types.

The technical advantage of using NCMA-types over NCM or NCA types is high capacity and lower cost resulting from higher nickel content and lower cobalt content. In addition NCMCA types offer improved cycle stability in comparison to NCM types.

In an equally preferred embodiment of the electrode according to the present invention, the PVdF content of the water-based binder (WBB) system may be chosen to be between 0% and 2%, wherein the range of 0,5 to 1%, 1 to 2% or even 0% may be even more preferred embodiments as well.

All % values in this application are provided as % per weight values.

To enable lamination of a separator to electrodes manufactured from aqueous solutions the most preferable binder content is 3-4%. This enables a stable interface between the separator and the electrodes and enhances the safety of the cell. However, lamination is not a must in the processing of WBB electrodes. The purpose of lamination is to make the separator more uniform and enhance stability within the cell, which helps for uniform solid electrolyte interphase (SEI) formation on the interface anode/separator. Due to the improved SEI formation on the anode side the cell degradation during cycling is lower. Due to the different chemical interface interaction between active mass and water-based binders, a higher reversible intercalation/deintercalation is achieved compared to PVdF binder electrodes, increasing the chemical-and electrochemical stability of the cathode.

Without lamination a lower content of binder is preferable, with the most preferable WBB amount being 2-3%.

The technical advantage of using a WBB amount of 2-3% is improving energy density of the cell and at the same time enhancing power density (cell power capability) due to the lesser isolation of the active material particles caused from large binder content.

The water-based binder system preferably is a carboxymethyl cellulose (CMC) based binder system, a Styrene Butadiene Rubber (SBR) binder system or an acrylic based binder system. WBB such as CMC based, SBR-based and/or acrylic based binders are showing higher binding abilities as PVdF binders, increasing the adhesion of the electrode mass to the current collector and interparticle cohesive adhesion thus making it possible to manufacture electrodes with lower binder amount.

The absence of organic solvents leads to more environment friendly processes which in turn result in a reduction in manufacturing cost. Protection of the environment is being given high priority in every phase of the product life cycle: it features saving of resources by waste reduction during manufacturing, separation technology in all areas of chemical processing, gas/water treatment through systematic recycling and raw materials recovery.

A cell assembly process starting with the electrode manufacturing based exclusively on a water-based binder (WBB) process improves the manufacturing environment by elimination of costly and toxic organic solvents. NMP and/or acetone are used heavily in lithium-ion battery manufacturing as a solvent for electrode preparation, though much effort is made to replace it with solvents of less environmental concern, like water. In contrast to the chemical solvents used in conventional industrial coating, which have to be subsequently recycled or burnt, water does not need recycling, vapor removal, or an ATEX (controlling explosive atmospheres) processing line. The machinery is thus simplified by not being at potential risk from explosive atmospheres. Furthermore, NMP has been included in April 2018 on the list of substances of very high concern that may have serious irreversible effects on human health and environment. The use of NMP has been restricted by the European Commission (restriction entry 71 of Annex XVII to REACH): NMP “Shall not be manufactured, or used, as a substance on its own or in mixtures in a concentration equal to or greater than 0.3% after 9 May 2020 unless manufacturers and downstream users take the appropriate risk management measures and provide the appropriate operational conditions to ensure that exposure of workers is below the Derived No-Effect Levels (DNELs) of 14.4 mg m⁻³ for exposure by inhalation and 4.8 mg kg⁻¹ per day for dermal exposure” which implies additional costs for the electrode processing chain, from mixing the slurry to the final solvent recovery.

The water-based binder in the slurry for the manufacture of an electrode according to the present invention may be chosen to be a carboxymethyl cellulose (CMC) binder, a Styrene Butadiene Rubber (SBR) binder, an acrylic binder, or mixtures thereof. Using more stable water-based binders increases cell safety.

Poly (vinylidene fluoride) (PVdF) is the most used binder in lithium-ion batteries today because of its excellent electrochemical stability, good bonding capability, high adhesion, and universality. Despite toxicity concern and high processing cost, the PVdF binder is dissolved in organic solvents such as traditional N-methyl-pyrrolidone (NMP) which is volatile, flammable, explosive, and high-toxic, leading to serious environment pollution. PVdF is very sensitive to moisture and leads to several battery failure mechanisms driven by volume changes, mechanical stress including pulverization of the active material, loss of contact with the current collector, cracking, and re-formation of the solid electrolyte interface (SEI) passivation layer, and loss of electrode porosity restricting ionic conduction. Also, both PVdF and NMP are expensive, which leads to higher production costs of lithium-ion batteries.

Aqueous or water-based binders have drawn more and more attention in recent years because of the advantages of low cost and environmental friendliness. The improved electrochemical stability for the electrodes containing water-based binders has been reported already in many publications, e.g. the cycle stability for the Li/SiOx electrodes containing various binder types (conventional PVdF Binder) is inferior to water-based Na-CMC and Li-PAA binder. Due to the different chemical interaction between active mass and water-based binders, a higher reversible intercalation/deintercalation is achieved compared to PVdF binder electrodes.

Finally, what is proposed according to the present invention as well is a method for the manufacture of an electrode for a lithium ion containing electrochemical cell, the method comprising the steps of preparing a slurry as described in the paragraphs above, coating or laminating the slurry on a current collector, and drying the slurry.

So, considering all the above, with the present invention, PVdF content in electrodes can be avoider and/or reduced, because of the water-based binders used in the slurry.

The overall binder content in electrodes can be reduced according to the invention, because of the improved recipes, improved binder types, and improved mixing techniques in order to control the pH value in the slurry in a range between 9 and 10,5.

The lamination of separators to electrodes manufactured from aqueous solutions according to the invention can be enhanced, because of the binder types used and proper surfactants to enhance the binder dispersion in the slurry.

The cohesive adhesion between particles within the electrode structure manufactured according to the invention can be enhanced because of the used binder types and increased solid content in the slurry which is resulting in less water to be taken out during drying of the electrode, which is resulting in less electrode porosity and a higher elasticity.

The chemical-and electrochemical stability for a cathode manufactured according to the invention can be enhanced, because of less electrode porosity and better inter-particle contact.

The cell safety can be increased through using more stable water-based binders according to the invention, because of the higher stability of water-based binder vs PVDF binders which is known to decompose (leading to the HF Evolution) at elevated temperatures and at high voltages.

The adhesion of the electrode mass to the current collector can be increased, by providing a higher solid content, i.e. all of the non-water content components, of 60% to 85% or better 75% to 85% in the slurry to make the electrode, by improved recipes, improved binder types, and improved mixing techniques in order to control the pH value of the slurry to be between 9 and 10,5.

The recyclability of the electrode material can be increased, because of the water-based binders which can be diluted in water

Finally, the manufacturing cost for electrodes (cathodes) can be reduced based on the present invention, since because of the use of water as a solvent, the coating process can run at much lower temperatures (NMP which is the traditional solvent used for the production of electrodes requires higher temperature due to its high boiling point). This results in the drying sections of the coater being shorter and using less energy to extract the solvent, in the present invention water. It enables use of smaller and faster machines that are more cost effective to run, which in turn will make batteries cheaper and more widely available. There is also no solvent recovery system required, as the emissions from the coater are steam that can be released into the atmosphere without any further treatment.

Still other aspects, features, and advantages of the present invention are readily apparent from the following detailed description, simply by illustrating preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description or may be learned by practice of the invention.

### Detailed Description of the Drawings

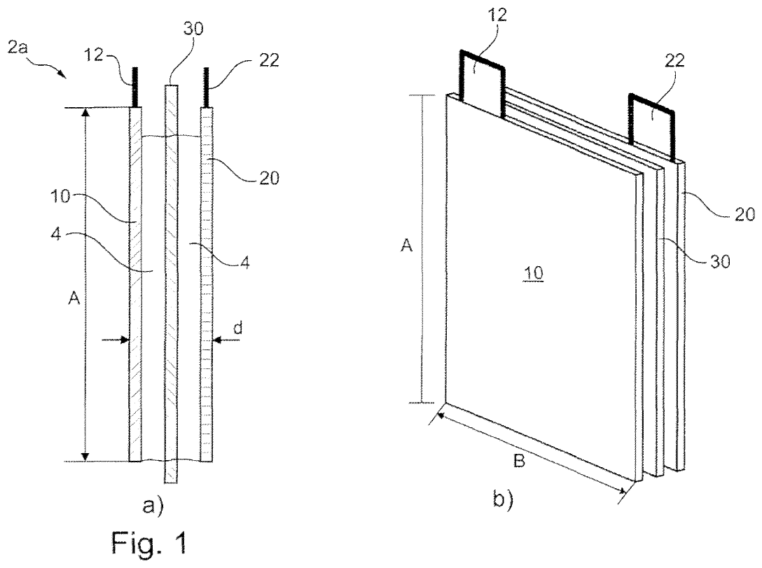

Fig. 1a and 1b show an example of an electrochemical cell 2 that may be used with the present disclosure. The electrochemical cell 2 comprises two electrodes, an anode 10, and a cathode 20. The anode 10 and the cathode 20 are separated by a separator 30. The anode 10 and the cathode 20 as shown are manufactured from a slurry comprising a water-based binder system and an electrochemically active compound with Li-metal oxides comprising Ni, wherein the Ni amount in Metal (LiMeO₂) is at least 80%.

In the preferred embodiment as shown the layered oxide cathode materials is Li_{1.2}Mn_{0.5100}Ni_{0.2175}Co_{0.0725}O₂, wherein the Ni amount in Metal (LiMeO₂) is 90%.

The electrochemically activatable compound of the preferred embodiment as shown is chosen from the group consisting of NMC-types, NCA-types, NCMA-types and High voltage Li-NMO (LiNi_{0.5}Mn_{1.5}O₄) types.

Furthermore, the electrode according to the preferred embodiment shown is made using a slurry in which the PVdF content of the water-based binder system is 0-2%, the pH value is between 9 and 10,5, and the solid content, i.e. all of the non-water content components, is 75% to 85%.

The water-based binder system used in the preferred embodiment as shown is a carboxymethyl cellulose (CMC) based binder system

The anode 10 and the cathode 20 have electrical contacts 12, 22 for electrically contacting the respective electrode. The separator 30 as shown is a ceramic separator as known in the art.

The electrochemical cell 2a as shown is a large format electrochemical cell. An electrochemical cell may be called a large format electrochemical cell if at least one of the electrodes 10, 20 and the separator 30 between the electrodes have a length A and/or a width B of at least about 10 cm or more. For example the length A and the width B of the electrodes 10, 20 can be about 10 to about 20 cm. The length A may be different than the width B allowing rectangular shapes or any other shape desired. The shape of the electrode may be adapted to the application of the electrochemical cell or battery and may be adapted to a particular casing.

In the shown example, the distance D between the anode 10 and the cathode 20 is less than 1 mm. For example, the distance between an anode collector of the anode 10 and a cathode connector of the cathode 20 may about 400 μm or less.

Each one of the electrodes 10, 20 of the anode 10 and the cathode 20 may be made of a foil material of a thickness of about less than 50 μm. In particular the foils may have a thickness of about 10 to 20 μm. For example, an aluminum foil may be used for the cathode and a copper foil may be used for the anode 10.

The electrochemical cell 2a is filled with an electrolyte 4 that is in contact with the anode 10 and the cathode 20.

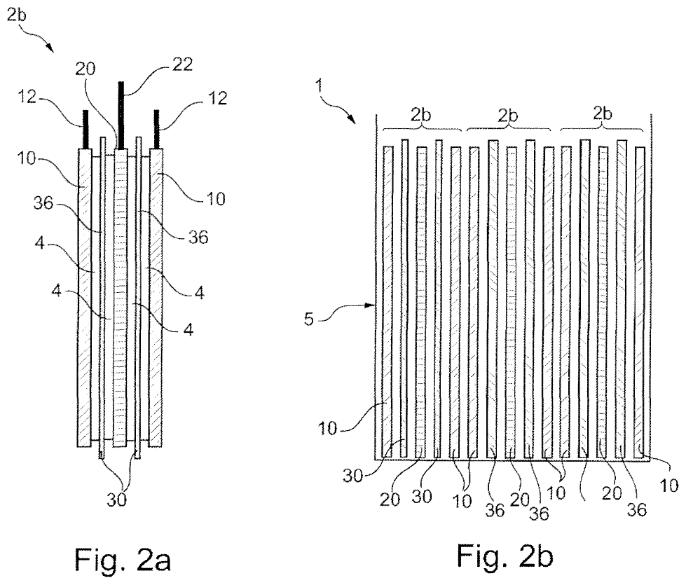

FIG. 2a shows an electrochemical cell 2b that differs from the electrochemical cell 2a in that at both sides of the cathode 20 a separator 30 and an anode 10 are arranged. The electrolyte 4 is inserted between each anode 10 and the cathode 20. This allows closer stacking of the electrochemical cells 2b in a battery 1 and requires less cathode material. The electrical contacts 12, 22 are omitted in the figures for clarity reasons.

A plurality of the electrochemical cells 2a as shown in FIGS. 1a and 1b or a plurality of electrochemical cells 2b as shown in FIG. 2a may be stacked on top of each other to form a rechargeable battery 1. FIG. 2b illustrates how a plurality of electrochemical cells 2b can be stacked in a housing, pack or pouch 5. The number of electrochemical cells 2 stacked can be varied according to the application of the rechargeable battery 1. In the example show, three electrochemical cells 2b are shown for illustrative purposes stacked to form a rechargeable battery 2, but the number of electrochemical cells 2a, 2b can be much higher. For example, a battery 2 may comprise up to about 500 electrochemical cells 2a, 2b.

The electrochemical cells 2a as shown in FIGS. 1a and 1b may simply be stacked on top of each other and the electrodes 10, 20 may be separated from each other using a separator material.

However, other stacking methods are also possible and applicable with the present invention. FIGS. 2-4 show electrochemical cells 2b in bicell-configuration. The cell can also be implemented in monocell-configuration, bipolar-configuration, as wound or Z-stacked cell.

The active masses or active materials can be coated single-sided or double-sided to the collector. Other stacking methods may be applied as well, such as alternating stacking of anodes and cathodes, each with a separator material in between. By doing this, it is possible to use both surfaces of the anode and of the cathode.

FIG. 2b shows a plurality of electrochemical cells 2b stacked in a package or pouch 5 in bicell-configuration, prior to filling electrolyte into the electrochemical cells 2b.

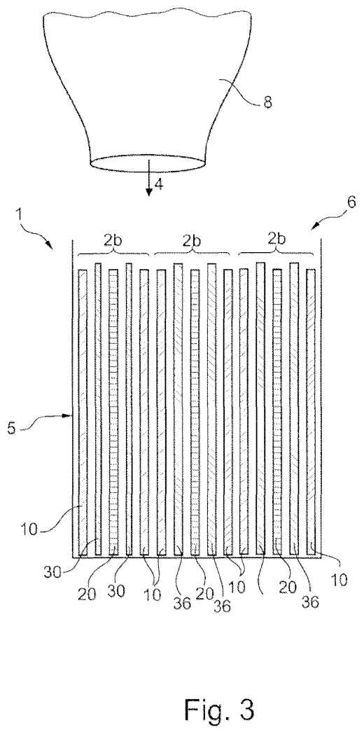

FIG. 3 shows how the electrolyte 4 may be inserted in the electrochemical cells 2a, 2b. The electrochemical cells 2a, 2b may be packed in a pouch 5 that is closed on all sites except the top side 6 using a dosing apparatus 8 such as a needle or the like. FIG. 3 shows a bicell-configuration of three pairs of electrochemical cells 2b, wherein the contacts 12, 22 are omitted for clarity reasons. The dosing apparatus 8 allows inserting an pre-determined amount of electrolyte 4 into the electrochemical cells 2a, 2b. Inserting the electrolyte 4 in the electrochemical cells 2a, 2b packed in the pouch 5 may be performed under vacuum conditions, for example at a pressure of about 10 to 500 mbar abs. The electrolyte 4 may be injected from one side only, substantially simplifying the injection procedure.

It is important to have a very homogenous distribution of electrolyte 4 between the anode 10 and the cathode 20, in particular, no bubbles or other errors shall be present between the anode 10 and the cathode 20, as this will lead to undesired defects and less battery capacities. The electrolyte 4 in batteries 1 according to the present invention may comprise a non-aqueous solvent such as, for example, a cyclic carbonate, a cyclic ester, a linear carbonate, an ether, or a combination thereof other organic solvents may be used.

The electrolyte 4 comprises conductive lithium salts such as for example LiClO₄, LiPF₆, LiBF₄, LiAsF₆ and LiPF₃(CF₂CF₃), Lithium bis[1,2-oxalato(2-)-O,O′] borate (LiBOB) based electrolytes, LiF₄C₂O₄, LiFOP, LiPF₄(C₂O₄, LiF₄OP, LiCF₃ SO₃, LiCAF,SO₃, Li(CF₃SO₂)₂N, Li(C₂F₅SO₂)₂N, LiSCN and LiSbF₆, LiAlO₄, LiAlCl₄, LiCl and Lil or a combination thereof other known lithium salts may be used as well.

The electrolyte 4 comprises a wetting agent. The wetting agent is used to homogenously wet the surfaces of the anodes 10, the cathodes 20 and the separator 30 and to obtain a homogeneous distribution of electrolyte 4 inside the electrochemical cells 2a, 2b. The wetting agent may be or may comprise a flouropolymer, in particular a fluorosurfactant.

Possible examples for fluoropolymers comprise commercially available perfiourinated alkyl ethoxylates such as Zonyl SFO, Zonyl SFN und Zonyl SF300 (E. I. DuPont). Li-thium-3-[(1H,1H,2H,2H-fluoralkyl)thio]-propionat, Zonyl FSA ©, Du Pont).

Commercially available examples of fluorosurfactants that may be used with the present disclosure comprise but are not limited to fluorosurfactants distributed by DuPont under the product name Zonyl SFK, Zonyl SF-62 or distributed by 3M Company under the product name FLURAD FC 170, FC 123, or L-18699A. Other commercially available product that may be used as fluorosurfactant comprise 3M Company products distributed under the product name Novec F-C4300, 3M FC-4430, 3M FC-4432, or 3M FC-4434.

Other wetting agents that may be used with the present disclosure comprise semi-fluorinated acryl polymer EGC-1700, Fluoromethacrylate, long-chain perfluoroacrylates, tetrafluorethylene, hexafluoropropylene, silane-coupling agent with perfluoropolyether (PFPE-5), (perfluoroalkyl)ethyl methacrylate-containing acrylic polymers, butyl methacrylate-co-perfluoroalkyl acrylate, semifluorinated fluorocarbon diblock copolymer poly(butyl methacrylate-co-perfluoroalkyl acryl ate), n-perfluorononane, perfluoropropyleneoxyde, polytetrafluoroethylene, poly(tetrafluoroethylene-co-hexafluoropropylene), perfluorobutyl (PFB), perfluoromethyl, perfluoroethyl or a combination thereof. All of the above wetting agents may be used alone or in any combination.

The wetting agents, fluoropolymers or fluorsurfactants may be used at a concentration of about 5 ppm (parts per million) to about 5000 ppm.

The use of the wetting agent in the electrolyte results in an even and homogeneous distribution of the electrolyte 4 in the electrochemical cell 2a, 2b. The use of the wetting agent allows reducing the filling times considerably and allows to manufacture large format lithium ion batteries in acceptable time scales suitable for mass production.

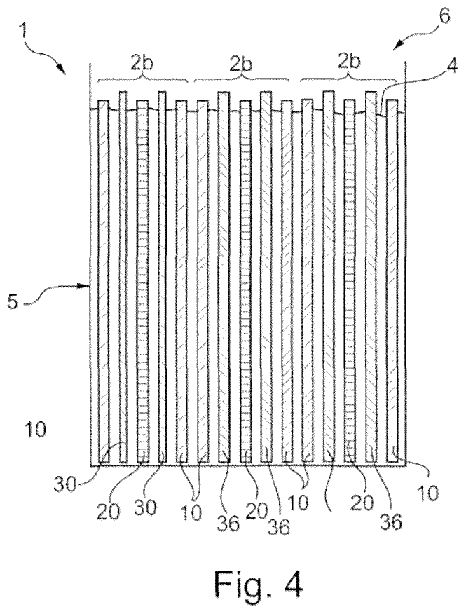

FIG. 4 shows a sealed battery pack 1, wherein the opening 6 of the pouch 5 has been closed after filling the battery pack 1 with electrolyte 4 has been completed.

It is obvious to a person skilled in the art that other possibilities than pouches 5 exist to pack the electrochemical cells 2a, 2b. For example, a battery housing from known plastics materials may be used.

It is obvious to a person skilled in the art that a plurality of battery packs 1 may combined to increase the capacity and/or voltage of the battery.

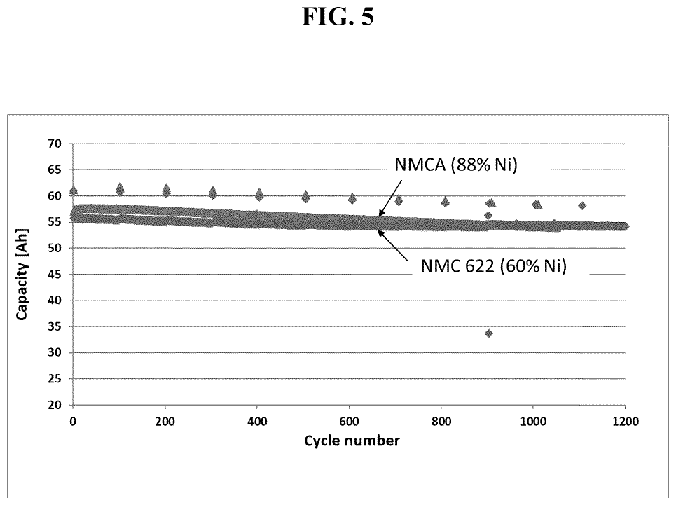

Finally, FIG. 5 shows a comparison graph depicting the charge/discharge (1C/1C) cycle stability for water-based binder electrodes: G/NMC622 (blue) and G/NMCA (88% Ni, in red). As can be taken from the graph in FIG. 5 the G/NMCA cell according to the invention shows a similar cycle stability as for a G/NMC622 cell, containing substantially less Ni.

The foregoing description of the preferred embodiment of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiment was chosen and described in order to explain the principles of the disclosure and its practical application to enable one skilled in the art to utilize the disclosure in various embodiments as are suited to the particular use contemplated. It is intended that the scope of the disclosure be defined by the claims appended hereto, and their equivalents. The entirety of each of the aforementioned documents is incorporated by reference herein.

What is claimed is:

1. A slurry for manufacturing an electrode for lithium-ion cells, wherein the slurry is a water-based binder system comprising an electrochemically active compound with Li-metal oxides comprising Ni, wherein the Ni amount in Metal (LiMeO₂) is at least 80% wt, and wherein the pH value in the slurry is adjusted to be between 9 to 10.5.

2. The slurry according to claim 1, wherein the electrochemically activatable compound is chosen from the group consisting of Lithium-Nickel-Mangan-Cobalt-Oxide-types, Lithium-Nickel-Cobalt-Aluminium-Oxide-types, high voltage Li-NMO (LiNi_{0.5}Mn_{1.5}O₄) and high voltage Li-NMA (LiNi_{1-x-y}MnₓAl_{y}O₂) types.

3. The slurry according to 1, wherein the PVdF content of the water-based binder system is chosen to be between 0% and 2% wt.

4. The slurry according to claim 3, wherein the PVdF content of the water-based binder system is 0% wt.

5. The slurry according to claim 3, wherein the PVdF content of the water-based binder system is between 0,5 and 1% wt.

6. The slurry according to claim 3, wherein the PVdF content of the water-based binder system is between 1 and 2% wt.

7. The slurry according to claim 1, wherein the water-based binder system comprises carboxymethyl cellulose (CMC).

8. The slurry according to claim 1, wherein the water-based binder system comprises Styrene Butadiene Rubber (SBR).

9. The slurry according to claim 1, wherein the water-based binder system comprises an acrylic based binder.

10. The slurry according to claim 1, wherein the solid content in the slurry is 60% to 85%.

11. The slurry according to claim 10, wherein the solid content in the slurry is 75% to 85%.

12. The slurry according to claim 1, wherein for adjustment of the pH value of the binder solutions acrylates, such as polyacrylic acid (PAA) or polyethylene-co-acrylic acid (PEAA), phosphoric acid, citric acid, LiH₂SO₄, LiH₂PO₄, or ammonia, is used.

13. An electrode for a lithium ion containing electrochemical cell, manufactured from a slurry according to claim 1.

14. An electrochemical cell, comprising an electrode according to claim 13.

15. A method for the manufacture of an electrode for a lithium ion containing electrochemical cell, the method comprising the steps of:
a. preparing a slurry according to claim 1,
b. coating or laminating the slurry on a current collector, and
c. drying the slurry.
